(19) United States
(12) Patent Application Publication
(10) Pub. No.: US 2011/0147573 A1
(43) Pub. Date: Jun. 23, 2011

(54) SENSOR CAP ASSEMBLY SENSOR CIRCUIT

(75) Inventors: Martin Liess, Wiesbaden (DE); Fred Plotz, Taunusstein (DE); Guido Lauck, Florsheim (DE); Stefan Naumann, Dreieich (DE)

(73) Assignee: PERKINELMER OPTOELECTRONICS GMBH & CO. KG, Wiesbaden (DE)

(21) Appl. No.: 12/673,492

(22) PCT Filed: Aug. 12, 2008
(86) PCT No.: PCT/EP08/06636

§ 371 Date: Mar. 7, 2011

(30) Foreign Application Priority Data
Aug. 20, 2007 (DE) 10 2007 039 228.3

(51) Int. Cl. H01J 5/16

(52) U.S. Cl. 250/239

(57) ABSTRACT

A sensor cap assembly includes a radiation shielding part provided with a radiation entrance opening, and a radiation-transmissive lens mounted from the outside to the shielding part. The lens is a thick lens with a ratio T/D of thickness (T) to diameter (D) of more than 0.10, preferably more than 0.15.

### BACKGROUND

1. Field

The aspects of the disclosed embodiments relate to a sensor cap assembly, a sensor having such a cap assembly and a circuit having such a sensor. Such cap assemblies and sensors are known from DE102004028022.

2. Brief Description of Related Developments

The sensors under consideration are radiation sensors for detecting electromagnetic radiation, particularly IR radiation, through its heating effect and accordingly electric impact on suitable sensing materials or material combinations. Naturally, the heating effect of weak radiation coming through a little sensor window is small, and thus sensitivity of the sensors is always an issue. The size of the radiation inlet window, and thus the amount of collectable radiation, is limited by the admissible size of the sensor housing and by mounting and other mechanical requirements.

DE102004028022 of the same applicant discloses a sensor for detecting electromagnetic radiation, particularly in the infrared range, comprising one or more sensor elements for detecting electromagnetic radiation, a housing in which the sensor element is disposed, and a radiation inlet window provided in the housing and closed by a material attached to the outside of the housing and transmissible for the radiation to be detected. The transmissible material is fixed to the housing by fixation means not disposed in the field of view of the sensor element. The closing material may be lens-shaped.

Other prior art is represented by DE10321649, DE102004032022, JP2001194227, JP2004226216, JP2005195435, JP2006058228, JP2006058229, JP2006153675, JP2006177848, JP2006203040, JP2006292552, JP2006300748, JP2006329950, KR20040016525, KR20040016526, US2004031924, US2006016995, WO2006122529.

### SUMMARY

The aspects of the disclosed embodiments provide a cap assembly, a sensor and a circuit leading to or having increased sensitivity for radiation to be detected.

These embodiments are disclosed in accordance with the features of the independent claims. Dependent claims are directed on preferred embodiments.

A sensor cap assembly comprises a radiation shielding housing portion provided with a radiation entrance opening, and a radiation-transmissive lens mounted from the outside to the housing portion and closing the opening. The lens is a thick lens with a ratio of lens thickness to lens diameter of more than 0.10, preferably more than 0.15, and more preferably even more than 0.2.

The thick lens attached to the outside of the housing has a strong focusing effect and thus refracts, if mounted to the outside, radiation that would from the outside hit the housing, into the opening so that the effective aperture is increased to more than the physical aperture. Since radiation collection and thus sensitivity is determined by the effective opening area, and the area goes with the square of the opening diameter, an effective-diameter increase of 1.2 would lead to a signal and thus sensitivity increase of almost 50%. Neither a thin lens nor a Fresnel lens would provide this effect because due to their comparatively flat appearance they do not gain distance from the housing and are thus not able to refract radiation into the opening. Since noise signal components do not primarily depend on the effective opening, the increased signal strength does not come with increased noise level so that the S/N ratio is also increased.

Preferably, the lens diameter is larger than the diameter of the radiation entrance opening, e.g. by at least the factor 1.1 or 1.2 or 1.3. Comment A Barlow: we need to define the minimum number, if we use the phrase “at least”. Or maybe change the phrase and use “within a range from 1.1 to 1.3”. Irrespective of, but preferably combinable with the lens shape, the cross sectional diameter or area of the opening is more than 60% or more than 70% and/or less than 90% or less than 80% than that of the cross sectional area defined by the inner wall of a tubular part of the housing.

The described dimensioning allows both a reasonably sized entrance opening, thus giving reasonable sensitivity, while providing also a sufficient rim for holding and fixing the lens member.

### BRIEF DESCRIPTION OF THE DRAWINGS

In the following, preferred embodiments will be described with reference to the attached drawings, in which:

FIG. 1 shows a cross-sectional view of a sensor cap assembly,

FIG. 2 shows an enlarged cross-sectional view of the rim portion of the mounted thick lens,

FIG. 3 shows embodiments of lenses,

FIG. 4 shows a cross-sectional view of a sensor,

FIG. 5 shows a side view of a circuit, and

FIGS. 6-9 show more embodiments of the sensor cap assembly.

### DETAILED DESCRIPTION OF THE DISCLOSED EMBODIMENTS

Generally speaking, same reference numerals in this specification shall denote same components. Features described in this specification shall be deemed freely combinable with each other as far as technical reasons do not withstand a combination.

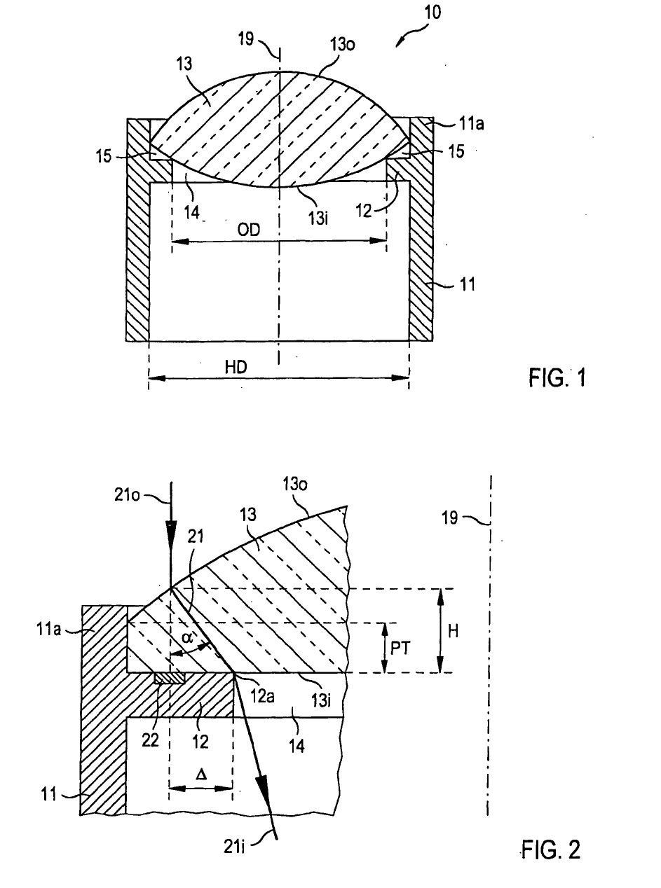

FIG. 1 shows a cross-sectional view of a sensor cap assembly 10. A radiation shielding part 11, 12 is provided with an opening 14. A lens 13 is provided for covering the opening 14. The lens is a thick lens with a ratio of lens thickness LT to lens diameter LD of more than 0.15, preferably more than 0.25. The lens, the radiation shielding part and the opening may all be of circular cross-sectional shape, and they may be concentric. 19 indicates the middle axis of such an arrangement. Preferably, the optical axis of lens 13 and the longitudinal axis of radiation shielding part 11, 12 coincide. The lens 13 has an outwardly pointing surface 13o and an inwardly pointing surface 13i.

The radiation shielding part may comprise a tubular part 11 and a holding part 12. The tubular part 11 may be of circular cross-section, and axis 19 may be the longitudinal symmetry axis of the tubular part 11. The holding part 12 may extend from the inner wall of the tubular part towards the inside, i.e. towards the axis 19. The holding part 12 may comprise the opening 14. For it alone, the holding part 12 may have a flat ring shape.

The lens 13 is mounted from the outside to the radiation shielding part 11, 12 such that it closes the opening 14. It may be attached to the light shielding part by suitable fixation means, such as mechanical fasteners, adhesive, or the like.

The fixation means of the lens may be to a larger part or fully out of the field of view of the sensor elements to be housed. Particularly, they may be provided in outside corner regions 15 between the tubular part 11 and the holding part 12.

The lens 13 may have two convex surfaces (i.e. both the inwardly pointing surface 13i and the outwardly pointing surface 13o being convex), or it may have a convex surface and a more or less flat surface, wherein the may be the inwardly pointing surface 13i. When two convex surfaces are provided, they may be of different radius of curvature. Then, the one with the smaller radius of curvature is preferably the outward pointing surface 13o.

FIG. 2 shows an enlarged view of the rim portion of the mounted thick lens for explaining the effect of the disclosed embodiments. 21 symbolizes an optical path for vertically (i.e. parallel to symmetry axis 19) incident light. It symbolizes the path that just finds its way around the inner upper corner 12a of the holding part 12. The depicted path 21 shows that an outward portion 210 of the path 21 is in a region that would, if not refracted, hit the holding part 12. However, upon incidence on the lens 13, the radiation is diffracted towards the optical axis 19 to include an angle [alpha] with the direction outside the lens 13. Traveling through the height H of the lens from the point of incidence towards corner 12a, the radiation also travels a distance Δ towards the symmetry axis. The relationship Δ=H·tan(α) applies. The angle α depends on the curvature of surface 13o. The heights H is determined by various factors such as lens geometry, mounting position and the like.

The effect is that radiation 210 that would be shielded is diffracted into the opening 14 so that the effective opening of window 14 is increased by Δ. For increasing the described effect (obtaining a large Δ), a large angle α and a large height H are desired. For this, a thick lens is desired, i.e. a lens having a comparatively small radius of curvature at least of the outer surface 13o. The radius of curvature may be smaller than the inner diameter HD of the tubular part 11 (horizontal direction in FIGS. 1 and 4).

22 denotes fixation means, for example glue or some kind of adhesive. It may be provided in one or more recesses of the radiation shielding part 11, 12, and/or in the lens 13. Such recesses may be provided in the horizontal part (outward surface of holding part 12 and/or its opposing lens surface) and/or in the vertical part (inner surface of tubular part 11 and/or its opposing lens surface). A fluid-tight seal (water-tight, gas-tight) may also be provided. This seal may be rendered by the fixation means 22 itself.

FIG. 2 shows an embodiment where the inner surface 13i of the lens is flat or at least of a much larger radius of curvature than the outer surface 13o. The holding part 12 is provided for rendering a defined mounting position of the lens in vertical direction. The lens is to be mounted such that in relation to the housing, the focal plane of the lens is in a predefined position so that focused radiation hits a sensor element provided in an overall sensor in a desired focusing state.

11a denotes a protruding portion of the tubular part 11. It may protrude in an outward direction (i.e. upward along axis 19 in FIGS. 1 and 2) beyond the outer rim of the lens 13. The protruding part 11a may form a centering means for the lens in that its inner circumference cross sectional shape may match or touch at least partially the outer contour of the lens 13. However, the protruding part 11a may also protrude much more than what is shown in FIGS. 1 and 2. It may protrude to more than the highest elevation of the lens 13 for rendering some kind of protection for the lens against mechanical impact, and it may protrude even more for rendering radiation shielding of radiation coming from unwanted oblique directions.

Altogether, the holding part 12 provides for the lens 13 a defined mounting position in axial direction (axis 19 in FIGS. 1 and 2), whereas the protruding part 11a provides a defined mounting position in radial direction (horizontal directions in FIGS. 1 and 2). Through this, mounting of the lens into the assembly becomes easy and quick, but nevertheless precise.

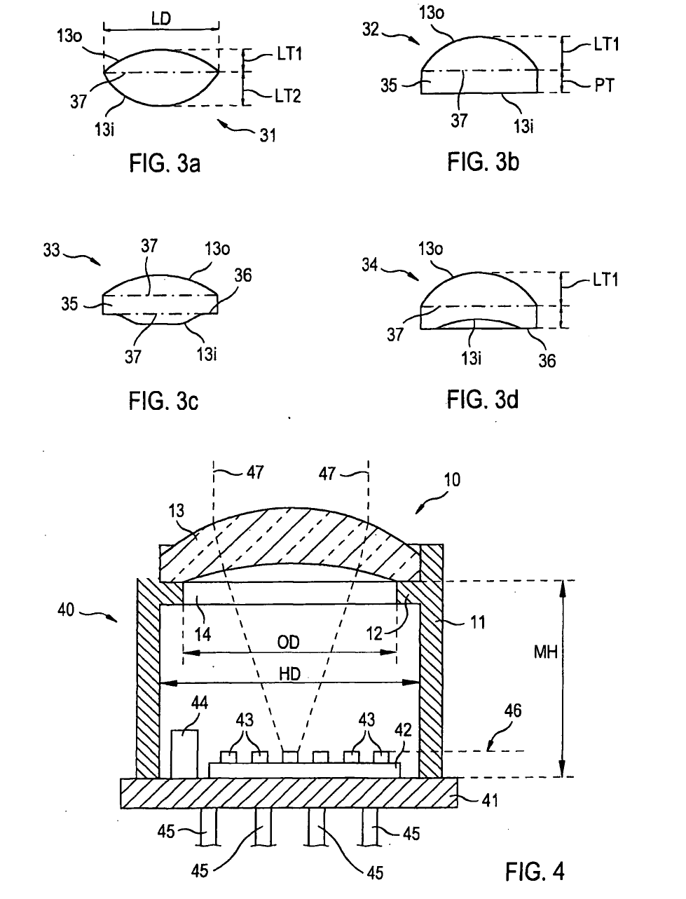

FIG. 3 shows various cross-sectional shapes of lenses 13. 31 is a lens with two convex surfaces 13o and 13i. They intersect each other in plane 37. The overall lens thickness is determined by a first component LT1 rendered by the outwardly pointing convex portion and a second component LT2 rendered by the inwardly pointing convex portion. The lens diameter LD is the horizontal extension of lens 31 in FIG. 3a. As lens thickness LT to be set in relation to lens diameter LD, either LT1 alone or the sum of LT1 and LT2 may be taken.

FIG. 3b shows another embodiment of a lens 13. This embodiment is a lens 32 with surfaces of different radius of curvature with the special case that the inner surface 13i is flat and thus has an infinite radius of curvature. 35 (the portion between line 37 and surface 13i) is a plate portion (formed as one piece with the overall lens) with a cylindrical outer surface corresponding in its contour to the overall contour of the lens and having a thickness PT. In this embodiment, the lens thickness LT may be the thickness LT1 of the convex portion alone, or it may be the sum of LT1 and PT. Lens 32 of FIG. 3b corresponds to that shown in FIG. 2.

FIG. 3c shows a further embodiment with two concave surfaces 13o and 13i, and a plate section 35 in between. Again, here the lens thickness LT to be set in relation to the lens diameter LD may be the thickness of the convex outer part alone, or it may be the outer convex portion thickness and the plate portion thickness.

FIG. 3d finally shows an embodiment having a concave inner surface 13i if, for some reasons, a long focal length is desired. In such embodiments, again the lens thickness LT to be set in relation to the lens diameter may be the thickness LT of the convex portion alone, or it may be the convex portion thickness LT plus the plate thickness PT.

FIGS. 3c and 3d show lenses 33 and 34 with a flat ring rim portion 36 suitable for directly sitting on the outwardly pointing surface of holding part 12. Through this ring rim portion 36, the mechanical connection may be established.

In all embodiments shown in FIG. 3, also the highest elevation of the lens 13 (in vertical direction—axis 19) above the outer plane of the holding part 12 or above corner 12a may be taken as lens thickness LT to be set in relation to lens diameter LD.

Generally speaking, according to the aspects of the disclosed embodiments, the radius of curvature of the outer surface 13o and the thickness PT of a possibly provided plate portion 35 may be used for establishing the value Δ in accordance with the above recited formula. The shape of the inner surface 13i may be chosen to obtain a finally desired focal length.

If a plate portion 35 is provided, its thickness may be at least 5% or at least 10% or at least 15% of the diameter of opening 15.

FIG. 4 shows the cross-section of an overall sensor 40. It comprises a sensor cap assembly 10 as described above. Further, a base plate 41 bears one or more sensing elements 43 which may be formed on an own substrate 42. The dashed line 46 symbolizes the focal plane of the lens 13 which should be in a predetermined relation with respect to the sensor element 43, preferably such that the sensor elements lie in the focal plane 46 or in a defined distance thereto. 45 symbolizes electrical contacts. 44 symbolizes electric and electronic circuitry (digital and/or analogue) for one or more of power supply, signal processing, data storing, program execution, A/D conversion, multiplexing and the like. Auxiliary sensors may be provided, e.g. for sensing the ambient temperature within the sensor 40.

13 is a lens formed similar to the embodiment shown in FIG. 3d. Axis 19 of the sensor cap assembly 10 may be perpendicular to the surface of the base plate 41 and/or to the focal plane 46.

47 symbolizes radiation from a detection target such as a human whose presence and location is to be detected. In good approximation, the incident radiation may be assumed to be parallel, as schematically symbolized by parallel dashed lines 47. Lens 13 focuses the radiation into the focusing plane 46 where the sensor elements 43 are located. Depending on the direction of incidence, the lens focuses the radiation onto differing spots in the focal plane 46. Depending on the distribution and provision of sensor elements 43, characteristic signal can be output. Circuit 44 may make signal evaluation from the individual sensor elements 43, may make signal shaping and signal processing, analogue/digital conversion, signal coding, and the like.

The sensor elements 43 may be provided in a regular array, such as a square array of n rows and m columns, n and m being integers. The quantity of sensors or rows and columns depends on the desired spatial resolution. Likewise, the array may be hexagonal or dedicated to particular sectors to be imaged, or irregular.

The opening diameter or area OD may be at least 60 or at least 70% of the housing inner diameter or area HD. It may be smaller than 90% or smaller than 80% of the housing diameter or area HD. Through this dimensioning, the holding part 12 has a sufficiently large opening 14 and allows a reliable fixation of the lens 13 at the same time. All of opening 14, tubular part Ii, and lens 13 may be of circular cross-section and may be arranged concentric to each other. The mounting height MH of the inwardly pointing mounting portion of the lens 13 above the lower edge of the radiation shielding part or tubular part 11 (i.e. the height above the base plate surface) may be less than 1.5 the housing diameter HD, preferably less than HD. Through this, a comparatively compact sensor can be built. The thick lenses that may be used according to the aspects of the disclosed embodiments allow strong focusing effects and thus short focal length and accordingly a housing of comparatively low heights.

The sensor elements may be or comprise thermal detectors of any kind, especially thermopiles, pyrodetectors or bolometers. The sensors 43 may have sensitivity, and particularly a sensitivity maximum, in the infrared range (wavelength e.g. >800 nm, <20 μm). The lens 13 may have radiation filtering properties. Its radiation transmissivity may have a maximum in the infrared range (wavelength e.g. >800 nm, <20 μm).

The fixation of the sensor cap assembly 10 at the base plate 41 may be fluid-tight. It may be made by gluing or adhesive, or by a screw mechanism or by clamping, or by a combination thereof.

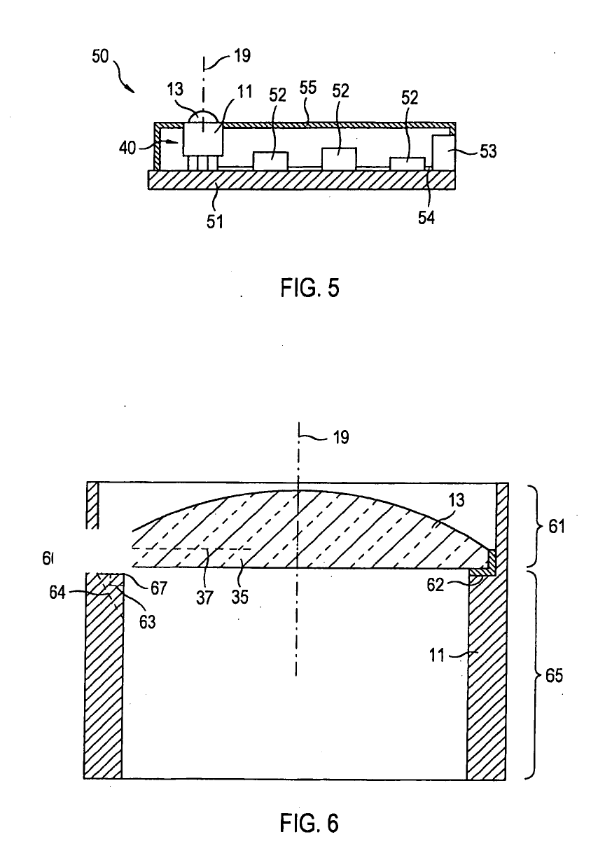

FIG. 5 shows a circuit 50 having a sensor 40 as described above. The circuit has a circuit substrate 51 such as a printed circuit board. Besides the sensor 40 it comprises circuit elements 52, a connecting means 53 and wiring 54. The sensor 40 may have its optical axis in a predefined relation to the surface of the circuit substrate 51. FIG. 5 indicates an embodiment where the optical axis 19 of the sensor 40 is perpendicular to the surface of the printed circuit board 51. But also other angles may be adjusted through the mounting position of the sensor. The optical axis may go in parallel to the surface of the circuit substrate 51.

The contacting means 53 may be a connector, or bonding pads, or soldering pads, or the like.

Circuitry 52 may again be for signal shaping and signal evaluation for rendering high level detection signals. A cover 55 may be provided for covering the overall circuitry, but having an opening through which sensor 40 may receive radiation. Another opening may be provided for contacting means 53.

FIGS. 6 to 9 show some more embodiments of sensor cap assemblies 11.

In FIG. 6, the shielding part has a tubular part 11 having an enlarged inner diameter portion 61 at the lens side end (top end in the figure) thereof. The lens is accommodated in said enlarged inner diameter portion. The transition from a normal inner diameter portion 65 to the enlarged inner diameter portion 61 may be as shown a one step structure 62 or may comprise plural steps 63 or an oblique wall portion 64, as indicated by dotted lines. By this construction, the lens increases the physical aperture rendered by the normal inner diameter portion 65 to a larger aperture which may be as large as the enlarged inner diameter portion. 66 denotes glue or adhesive for fixing the lens 13 at the tubular part 11. 67 denotes the corner around which the thick lens refracts radiation for rendering the aperture-enlarging effect. It corresponds to corner 12a in FIG. 2.

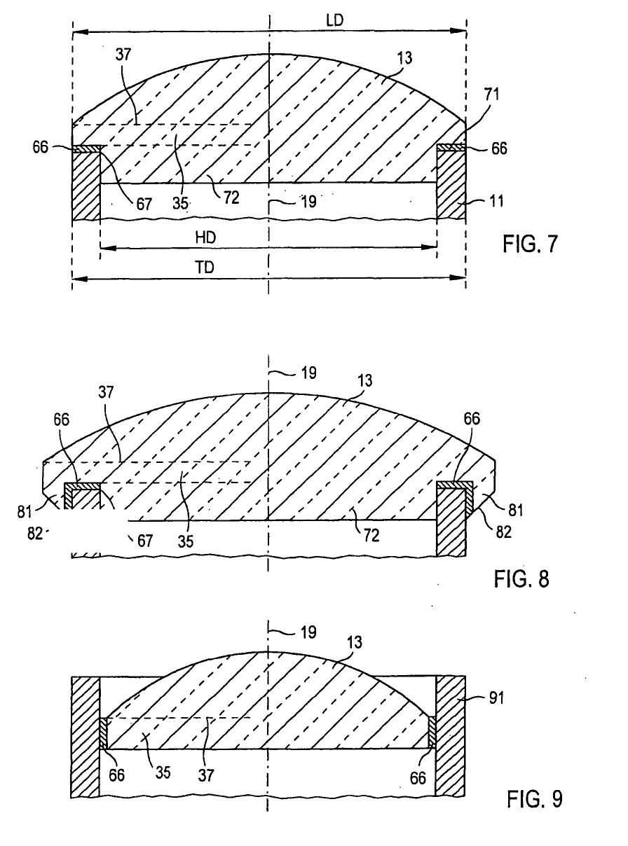

In FIG. 7, the lens 13 has a diameter LD larger than the inner diameter of a tubular part of the shielding part 11 at the lens-side end thereof and covers at least partially the top cut surface 71 of the tubular part 11. The lens diameter may be the outer diameter TD of the tubular part 11, or may be smaller. The lens may have a portion 72 extending into the tubular part, which may have a form-fit in relation to the inner wall thereof. By this construction, the lens 13 increases the physical aperture rendered by the inner diameter at the top end of the tubular part 11 to a larger aperture which may, depending on further parameters, be as large as the diameter of the lens.

The lens may also have a diameter larger than the outer diameter (TD) of the tubular part, as shown in FIG. 8. Thus, the lens extends in an outward direction (horizontally away from axis 19 in the figures) beyond the outer rim of the tubular part. By this construction, the lens increases the physical aperture rendered by the inner diameter at the top end of the tubular part to a larger aperture which may, depending on further parameters, be larger than the outer diameter of the tubular part and may be as large as the diameter of the lens.

The lens may have a portion extending into the inside of the tubular part, which may have a form-fit in relation thereto. Likewise, the lens may have a portion 81 extending along the outside of the tubular part in axial direction, which may have a form-fit in relation thereto. These extending portions may render centering of the lens. The lens may have an oblique wall portion 82 reaching from the lens outer diameter towards the outer wall of the tubular part.

FIG. 9 shows another embodiment. There, the radiation shielding part 11, 12 is a tube. The top opening of the tube forms the radiation entrance opening and accommodates the lens mounted to the inside of the tube.

In all of the embodiments of FIGS. 6 to 9, the fixation of the lens 13 and the thickness determinations thereof may be made as said earlier. But in all of the shown embodiments, in addition to, or instead of, glue or adhesive, the lens may be clamped into the opening of the tubular part. Vertically abutting walls may also have a thread construction instead of, or in addition to, the already mentioned mechanisms.

The sensor cap and the sensor itself may be adapted for use at low temperatures, preferably below 160° C. The field of view of one sensor element may be smaller than 40° or smaller than 30°. This may be accomplished by a suitable optical layout, or by shielding radiation by protruding portions 11a. The lens may be made of, or comprise, transparent resin or glass. The lens may also be made of or comprise inorganic semiconductor material such as Silicon or Germanium. The lens may comprise a wavelength selective coating according to the desired sensitivity, preferably at its inside surface 13i. The lens may also comprise a reflection-reducing coating, preferably at its outside surface 13o.

The tubular part may be of circular cross-sectional shape or of other cross-sectional shape. The tubular part may be a turning work piece or a cast body. The outer contour of the lens or portions of the outer contour may correspond to the cross-sectional shape of the tubular part.

Upper limit values for the lens diameter may be 10 mm, 8 mm or 5 mm. Lower limit values may be 1 mm or 3 mm or 5 mm. The overall height of the sensor cap assembly may have an upper limit value of 15 mm or of 10 mm.

What is claimed is:

1. A sensor cap assembly comprising:
a radiation shielding part provided with a radiation entrance opening, and
a radiation-transmissive lens mounted from the outside to the shielding part for covering the opening,
wherein the lens is a thick lens with a ratio LT/LD of thickness (LT) to diameter (LD) of more than 0.10, preferably more than 0.15.

2. The assembly of claim 1, wherein the shielding part has a tubular part and a holding part extending from the inner wall of the tubular part towards the inside of the tubular part, the opening being provided in the holding part.

3. The assembly of claim 2 wherein the tubular part has a protruding portion protruding beyond the outer surface of the holding part.

4. The assembly of claim 2 wherein the lens is fitted into the tubular part.

5. The assembly of claim 4 wherein a radial outward portion of the lens is bonded by fixation means to the shielding part, preferably to the tubular part.

6. The assembly according to claim 5 wherein the tubular part is of circular cross-section and the opening is centered on the axis of the tubular part.

7. The assembly according to claim 2 wherein the inner surface of the tubular part and the outer circumference of the lens are of matching contour.

8. The assembly according to claim 1 wherein the lens has two sides of different curvature, wherein the stronger curbed side faces towards the outside of the assembly.

9. The assembly of claim 6, wherein the lens has a inner side facing towards the inside of the assembly, the inner side having a radius of curvature of at least two times that of the outer side, and preferably being flat, wherein the lens is bonded via first side portions thereof to the holding part.

10. The sensor cap assembly, according to claim 1, comprising:
a radiation shielding part provided with a radiation entrance opening, and
a radiation-transmissive lens mounted from the outside to the shielding part,
wherein the shielding part has a tubular part and a holding part extending from the inner wall of the tubular part towards the inside of the tubular part, the opening being provided in the holding part,
wherein the area of the opening is more than 36% or more than 49% and or less than 90% or less than 80% than that of the area defined by the inner wall of the tubular part.

11. The assembly according to claim 1, wherein the shielding part has a tubular part having an enlarged inner diameter portion at the lens side end thereof, the lens being accommodated in said enlarged inner diameter portion.

12. The assembly according to claim 11, wherein the lens has a diameter larger than the inner diameter of a tubular part of the shielding part and covers at least partially the top cut surface of the tubular part.

13. The assembly of claim 12, wherein the lens has a diameter larger than the outer diameter (CD) of a tubular part of the shielding part and extends in an outward direction beyond the outer rim of the tubular part.

14. The assembly of claim 12, wherein the lens has portions opposing the inner wall and/or the outer wall of the tubular part.

15. The assembly of claim 1, wherein the radiation shielding part is a tube, the opening of which forms the radiation entrance opening and accommodates the lens.

16. The assembly according to claim 1, further comprising that:
it is adapted for use at low temperatures, preferably below 160° C.
the field of view of one sensor element is smaller than 30°. The lens is made of or comprises inorganic semiconductor material such as Silicon or Germanium.
the lens comprises a wavelength selective or anti-reflective coating, preferably at its inside.

17. A sensor comprising:
a substrate,
a sensing part comprising one or more sensor elements, and
electrical contacts,
further comprising:
a cap assembly according to claim 1.

18. The sensor of claim 17, further comprising that:
the sensing part is disposed in a predefined relation, and preferably in-plane, with respect to the focal plane of the lens.

19. A circuit comprising:
a circuit substrate,
one or more circuit elements mounted on the substrate,
electrical contact means, and
wiring on the substrate amongst the circuit elements and/or the contact means,
characterized in further comprising:
a sensor according to claim 17 mounted on the circuit substrate.
